(19) United States
(12) Patent Application Publication
(10) Pub. No.: US 2010/0162233 A1
(43) Pub. Date: Jun. 24, 2010

(54) METHOD AND SYSTEM FOR DISTRIBUTING BUNDLED APPLICATIONS

(75) Inventors: Kyoung I KU, Seoul (KR); Ki Hyuk NAM, Daejeon (KR); Ki Heon KIM, Iksan-si (KR); Moon Young CHUNG, Daejeon (KR); Won Young KIM, Daejeon (KR); Wan CHOI, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/549,873

(22) Filed: Aug. 28, 2009

(30) Foreign Application Priority Data
Dec. 19, 2008 (KR) 10-2008-0130216

(51) Int. Cl. G06F 9/445

(52) U.S. Cl. 717/178; 717/177; 717/174

(57) ABSTRACT

Provided are a method and system for distributing bundled applications, which represent the installation and execution relationships of an application based on the work relevance and bundle corresponding applications together to distribute the bundled applications. A plurality of applications for distribution are converted into a plurality of distributable applications. A meta information file including information on installation and execution relationships of the distributable applications is generated. A bundled applications distribution copy including a plurality of distributable applications and the meta information file is generated and distributed.

### CROSS-REFERENCE TO RELATED APPLICATIONS

This application claims priority under 35 U.S.C. §119 to Korean Patent Application No. 10-2008-0130216, filed on Dec. 19, 2008, in the Korean Intellectual Property Office, the disclosure of which is incorporated herein by reference in its entirety.

### TECHNICAL FIELD

The following disclosure relates to an application distributing technology, and in particular, to a method and system for distributing bundled applications, which represent the installation and execution relationships of the applications based on the work relevance of a user, and bundle corresponding applications together to distribute the bundled applications to improve workability.

### BACKGROUND

Application software is classified into an installed package application, which is created with development tools and execution file formats provided from each platform such as Windows or MacOS and Unix/Linux, a streaming application, in which pertinent package application is served on-line, a web-based application, and a non-installation portable application. Herein, each of the applications other than the package applications requires its own execution engine.

A related art application distributing technology is relevant to a package application distributing technology and a web-based application distributing technology. A package application is an application which is installed and used in each user's computer. As the package application distributing technology, a binary generating technology for application installation is widely used. A package application can be changed into a non-installation portable application in order to execute the package application without installation for the distribution purpose. A web-based application is an application based on web-related standard protocols such as HTML and HTTP. In this case, a user requests a file to a local web server or web server on networks, and executes the transmitted file through a web browser. The web-based application distributing technology is a technology that easily downloads, distributes and executes a web-based application as one file, which enables the web-based application to have mobility.

According to the related art application distributing methods, a user receives, installs and executes an individual application, or receives applications that a package application provider bundles and distributes together, to thereby execute the received applications irrespective of the relevance of work. Since users should search installation-dependent applications or execution-dependent applications in a communication network by themselves to download and install or execute the searched applications for establishing their own work environments, it is difficult for the users to implement their work environments.

### SUMMARY

In one general aspect, a method for distributing bundled applications includes: converting a plurality of applications for distribution into a plurality of distributable applications; generating a meta information file including information on installation and execution relationships of the distributable applications; and generating and distributing a bundled applications distribution copy including the meta information file.

The method for distributing bundled applications may further include downloading the bundled applications distribution copy to install and execute a plurality of applications of the bundled applications distribution copy.

In another general aspect, a system for distributing bundled applications includes: a storage storing a plurality of applications; a first application converting tool converting a plurality of applications for distribution selected from the stored applications into a plurality of distributable applications; and a second application converting tool bundling the distributable applications together to generate a bundled applications distribution copy.

In another general aspect, a system for distributing bundled applications includes: an application execution tool interpreting a meta information file of a bundled applications distribution copy, and installing a plurality of applications of the bundled applications distribution copy; and first to third execution engines executing the installed applications.

In another general aspect, a system for distributing bundled applications includes: a first computer converting a plurality of applications for distribution to generate and distribute a bundled applications distribution copy; and a second computer installing a plurality of applications of the bundled applications distribution copy which is downloaded from the first computer, and executing the installed applications.

### BRIEF DESCRIPTION OF THE DRAWINGS

FIG. 1 is a block diagram of a system for distributing bundled applications according to an exemplary embodiment.

FIG. 2 is a flowchart illustrating a method for distributing bundled applications according to an exemplary embodiment.

FIG. 3 is a flowchart illustrating the installation and execution process of bundled applications in the method for distributing bundled applications according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

For the creation of videos, a user needs applications for video edition, caption edition, sound edition, etc. If necessary applications are provided as “a bundle of UCC creation applications” or “a bundle of image edition applications” over a communication network, a user can easily and conveniently perform a desired work by using those applications. Accordingly, if necessary applications and the information of the installation-dependency and execution-dependency between the applications are bundled and distributed together, users can implement their own work environments easily and conveniently by installing and executing the bundled applications.

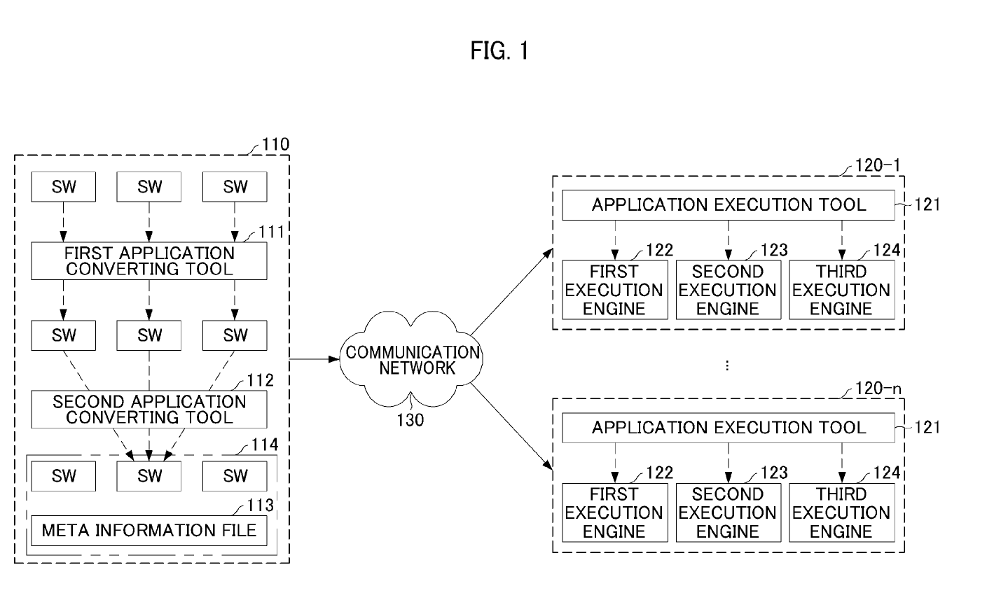

FIG. 1 is a block diagram of a system for distributing bundled applications according to an exemplary embodiment.

Referring to FIG. 1, a system 100 for distributing bundled applications according to an exemplary embodiment includes a computer 110 and a plurality of computers 120-1 to 120-n (n is a natural number more than 1). The computer 110 bundles applications (SWs) for distribution to generate and distribute a bundled applications distribution copy. The plurality of computers 120-1 to 120-n install the applications of the bundled applications distribution copy which is downloaded from the computer 110, and execute the installed applications.

The computer 110 includes a first application converting tool 111 and a second application converting tool 112. The first application converting tool 111 converts the applications (SWs) for distribution into distributable form. The second application converting tool 112 bundles the distributable applications together to generate and distribute the bundled applications distribution copy.

The first application converting tool 111 selects the applications for distribution from a plurality of applications stored in a storage (not shown) according to the control of a user, converts the selected applications for distribution into the distributable applications, and transfers the converted applications to the second application converting tool 112. Herein, the first application converting tool 111 may convert the applications for distribution into the distributable applications according to a streaming type, a non-installation portable application conversion type or a web-based application distribution type.

The second application converting tool 112 interprets the installation and execution relationships between the distributable applications which are converted through the first application converting tool 111, and generates a meta information file 113 including the information of the interpreted installation and execution relationships. Furthermore, the second application converting tool 112 bundles the distributable applications together to generate a bundled applications distribution copy 114 including the meta information file 113, and distributes the generated distribution copy 114 to at least one of the computers 120-1 to 120-n over a communication network 130.

Each of the computers 120-1 to 120-n includes an application execution tool 121, and first to third execution engines 122 to 124. The application execution tool 121 installs the applications of the bundled applications distribution copy 114 which is downloaded from the computer 110. The respective first to third execution engines 122 to 124 execute the installed applications.

The computers 120-1 to 120-n download the bundled applications distribution copy 114 from the computer 110 over the communication network 130 according to the control of a user. Then, the application execution tool 121 is executed by the click of the user to unbundle the bundled applications distribution copy 114. Next, the application execution tool 121 interprets the meta information file 113 of the bundled applications distribution copy 114 to acquire the information of the installation and execution relationships of the applications of the bundled applications distribution copy 114.

The application execution tool 121 installs the applications of the bundled applications based on the acquired information of the installation relationships. At this point, the first to third execution engines 122 to 124 execute the installed applications based on the acquired information of the installation relationship, respectively.

Herein, the first execution engine 122 is a streaming application execution engine, and executes an application which is converted into the streaming type. The second execution engine 123 is a non-installation portable application execution engine, and executes an application which is converted into the non-installation portable application conversion type. The third execution engine 124 is a web-based application execution engine, and executes an application which is converted into the web-based application distribution type.

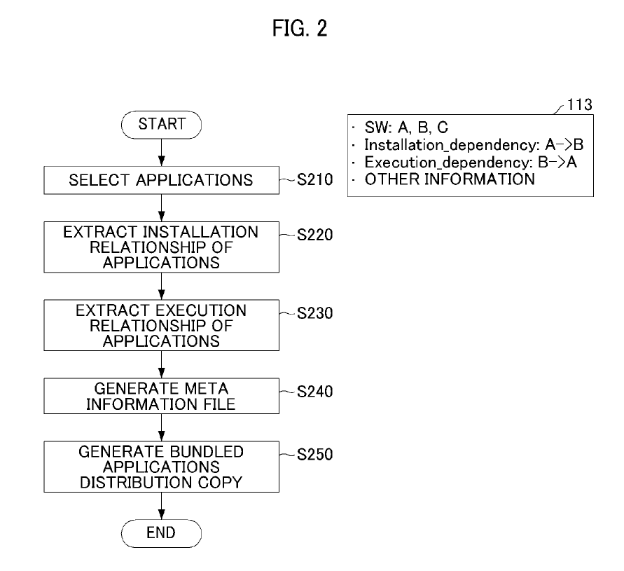

FIG. 2 is a flowchart illustrating a method for distributing bundled applications according to an exemplary embodiment.

Referring to FIG. 2, when information on applications for distribution is inputted from a user, the computer 110 selects applications for distribution from a plurality of stored applications on the basis of the input information, and converts the selected applications for distribution into distributable applications in step S210. Herein, the computer 110 converts the applications for distribution into the distributable applications according to the streaming type, the non-installation portable application conversion type and the web-based application distribution type.

The computer 110 extracts the installation relationship of the distributable applications in step S220, and extracts the execution relationship of the distributable applications in step S230.

The computer 110 generates a meta information file 113 including the information of the extracted installation and execution relationships in step S240. Subsequently, the computer 110 bundles the distributable applications together to generate the bundled applications distribution copy 114, which includes the meta information file 113 on the basis of the extracted installation and execution relationships, in step S250.

For example, in case that a user has determined the distribution of applications A, B and C, the computer 110 represents the corresponding information of the installation and execution relationships as the meta information file 113 (which is illustrated in FIG. 2) such that the application B should be installed after the installation of the application A or that the application C should be executed after the execution of the application B.

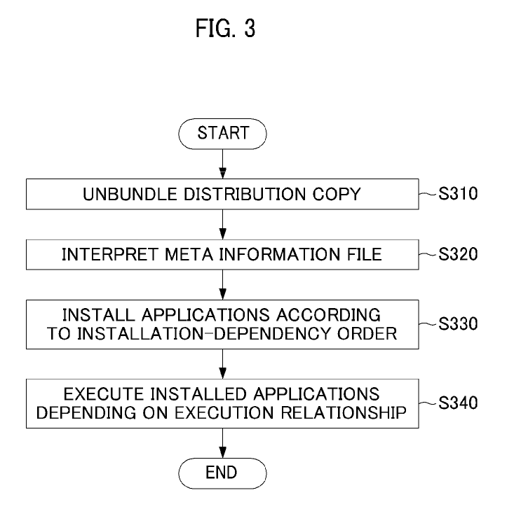

FIG. 3 is a flowchart illustrating the installation and execution process of bundled applications in the method for distributing bundled applications according to an exemplary embodiment.

Referring to FIG. 3, the computers 120-1 to 120-n unbundle the bundled applications distribution copy 114 which is downloaded from the computer 110 over the communication network 130 in step S310.

After unbundling the bundled applications distribution copy 114, the computers 120-1 to 120-n interpret the meta information file 113 of the bundled applications distribution copy 114 to acquire information on the installation and execution relationships of the applications of the bundled applications distribution copy 114 in step S320.

The computers 120-1 to 120-n install the applications of the bundled applications according to the acquired installation-dependency order in step S330, and thereafter execute the installed applications depending on the acquired execution relationship in step S340.

The users of the computers 120-1 to 120-n download the bundled applications distribution copy 114 to install and execute the applications, thereby implementing their work environments at one time.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for distributing bundled applications, the method comprising:
converting a plurality of applications for distribution into a plurality of distributable applications;
generating a meta information file comprising information on installation and execution relationships of the distributable applications; and
generating and distributing a bundled applications distribution copy comprising the meta information file.

2. The method of claim 1, wherein the converting of a plurality of applications comprises:
selecting the applications for distribution from a plurality of stored applications on the basis of input information; and
converting the applications for distribution into the distributable applications.

3. The method of claim 2, wherein the converting of the applications comprises converting the applications for distribution into the distributable applications according to a streaming type, a non-installation portable application conversion type and a web-based application distribution type.

4. The method of claim 1, wherein the generating of the meta information file comprises:
extracting the installation relationship of the distributable applications;
extracting the execution relationship of the distributable applications; and
generating the meta information file comprising the extracted information of the installation and executions relationships.

5. The method of claim 1, wherein the bundled applications distribution copy is distributed over a communication network.

6. The method of claim 1, further comprising downloading the bundled applications distribution copy to install and execute a plurality of applications of the bundled applications distribution copy.

7. The method of claim 6, wherein the installing and executing of a plurality of applications comprises:
downloading the bundled applications distribution copy;
unbundling the bundled applications distribution copy;
interpreting the meta information file of the bundled applications distribution copy to acquire information on installation and execution relationships of the applications of the bundled applications distribution copy;
installing the applications on the basis of the acquired information; and
executing the installed applications.

8. The method of claim 7, wherein the installing of the applications comprises installing a plurality of applications of the bundled applications according to an installation-dependency order comprised in the meta information file.

9. The method of claim 8, wherein the executing of the installed applications comprises executing the installed applications on the basis of the acquired information of the execution relationship.

10. A system for distributing bundled applications, comprising:
a storage storing a plurality of applications;
a first application converting unit changing a plurality of applications for distribution selected from the stored applications into a plurality of distributable applications; and
a second application converting unit bundling the distributable applications together to generate a bundled applications distribution copy.

11. The system of claim 10, wherein the bundled applications distribution copy is distributed over a communication network.

12. The system of claim 10, wherein the first application converting unit converts the applications for distribution into the distributable applications according to a streaming type, a non-installation portable application conversion type or a web-based application distribution type.

13. The system of claim 10, wherein the second application converting unit interprets installation and execution relationships between the distributable applications, generates a meta information file comprising information of the interpreted installation and execution relationships, and bundles the distributable applications together to generate the bundled applications distribution copy comprising the meta information file.

14. A system for distributing bundled applications, comprising:
an application execution unit interpreting a meta information file of a bundled applications distribution copy, and installing a plurality of applications of the bundled applications distribution copy; and
first to third execution engines executing the installed applications.

15. The system of claim 14, wherein the application execution unit interprets the meta information file of the bundled applications distribution copy to acquire information on installation and execution relationships of the applications of the bundled applications distribution copy, and installs a plurality of applications of a bundled applications based on the acquired information of the installation relationship.

16. The system of claim 15, wherein the first to third execution engines execute the installed applications based on the acquired information of the execution relationship.

17. The system of claim 16, wherein:
the first execution engine is a streaming application execution engine executing an application which is converted into a streaming type,
the second execution engine is a non-installation portable application execution engine executing an application which is converted into a non-installation portable application conversion type, and
the third execution engine is a web-based application execution engine executing an application which is converted into a web-based application distribution type.

18. A system for distributing bundled applications, comprising:
a first computer converting a plurality of applications for distribution to generate and distribute a bundled applications distribution copy; and
a second computer installing a plurality of applications of the bundled applications distribution copy which is downloaded from the first computer, and executing the installed applications.

19. The system of claim 18, wherein the first computer stores a plurality of applications, changes the applications for distribution selected from the stored applications into a plurality of distributable applications, and bundles the distributable applications together to generate a bundled applications distribution copy.

20. The system of claim 18, wherein the second computer unbundles the bundled applications distribution copy, interprets a meta information file of the bundled applications distribution copy to acquire information on installation and execution relationships of the applications of the bundled applications distribution copy, installs a plurality of applications of a bundled applications based on the acquired information of the installation relationship, and executes the installed applications based on the acquired information of the execution relationship.
